(19) United States
(12) Patent Application Publication
(10) Pub. No.: US 2017/0306218 A1
(43) Pub. Date: Oct. 26, 2017

(54) SYNTHETIC NANOCOMPOUNDS IN THE FORM OF MICROPARTICLES, PROCESS FOR PRODUCING SAME, PROPPING AGENTS AND FRACTURING FLUIDS FOR GAS AND OIL EXTRACTION PROCESSES

(71) Applicants: Guido M. HACKLÄNDER, Madrid (ES); SOTRO FINANCIAL INC., Ciudad de Panama (PA); SEPP, S.R.L., Ciudad de Buenos Aires (AR)

(72) Inventors: José M. CARELLA, Mar del Plata (AR); Carlos A. L. PIACENTINI, Mar del Plata (AR); Claudio J. PEREZ, Mar del Plata (AR); Juan P. TOMBA, Mar del Plata (AR)

(21) Appl. No.: 15/502,497

(22) PCT Filed: Jul. 6, 2015
(86) PCT No.: PCT/ES2015/070526

§ 371 Date: Jul. 10, 2017

(30) Foreign Application Priority Data
Jul. 7, 2014 (AR) P20140102521

(51) Int. Cl. C09K 8/80; C08F 212/08

(52) U.S. Cl. CPC C09K 8/80; C08F 212/08

(57) ABSTRACT

The invention relates to synthetic nanocompounds in the form of microparticles that allow major deformations before breaking and are especially useful for preparing low-density synthetic propping agents to be used in non-conventional oil and gas extraction processes (fracking). The invention also describes the process for obtaining said nanocompounds, propping agents and fracturing fluids for oil and gas extraction processes.

### TECHNICAL FIELD OF THE INVENTION

This invention relates to the field of high modulus, high tenacity synthetic nanocomposites in microparticle form, widely used in various industries. In particular, this invention refers to the design and production process of said microparticles, the use thereof as low density synthetic proppants, and a fluid comprising them. The proppants comprising the particles of the present invention can be used especially in unconventional oil and gas extraction processes, also known as “fracking”.

Although this invention specifically focuses on the application of these new proppants to the oil and gas extraction industry, by means of known fracture fluids, it is important to stress that the material in microparticle form of the present invention can also be used in other fields: as bearings for the slide of heavy parts in the construction and mechanical industries, as torque reducers in the drilling of oil wells and other types of wells, etc.

### STATE OF THE ART PRIOR TO THE INVENTION

The use of microparticles generically known as proppants is widely known in the field of unconventional oil and gas extraction. The definition of proppants comprises sands and ceramic particles suspended within fluids used to fracture the matrix. All materials in particle form used as proppants function by filling in the fractures caused by the injection of a highly pressurized fracture fluid, in order to prevent the fractures from closing once the pressure of the fluid is reduced. The proppant keeps the rocks separated and props the fractures open, thereby allowing the oil/gas to flow and be extracted. Initially, various natural and treated sands were used as proppants. In the past few years, several synthetic proppants exhibiting numerous operative advantages, such as uniformity of size, roundness, hardness, tenacity and low density, have been developed.

Particles made of styrene and divinylbenzene copolymers have been used for over 60 years in different industrial and laboratory applications and were always obtained using similar production processes. A brief description of the state of the art, regarding the production and use of low density synthetic proppants obtained from crosslinked styrene copolymers, can be found in several patent documents describing different aspects of the same type of product, including improvements designed to optimize its mechanical properties: U.S. Pat. No. 6,248,838, U.S. Pat. No. 8,278,373, U.S. Pat. No. 5,531,274, U.S. Pat. No. 6,059,034, U.S. Pat. No. 6,330,916, U.S. Pat. No. 6,451,953, U.S. Pat. No. 7,803,740, U.S. Pat. No. 7,902,125 and U.S. Pat. No. 8,088,718. The most important innovations contained in some of these documents are briefly described below.

All of the products described in the prior art are styrene copolymers synthesized using methods that may give rise to linear polystyrene chains, since the styrene exhibits monofunctional behavior in a free-radical homopolymerization reaction. In order to change the chemical structure and some chemical, thermal and mechanical properties, crosslinking agents, such as divinylbenzene and others with 2 or more functional groups, are added; said agents contribute chemical crosslinks, which increase the Glass Transition Temperature (Tg) of the resulting copolymer having a three-dimensional lattice structure. The chemical crosslink grants the resulting copolymer higher resistance to “creep” (deformation under constant pressure) and highly reduces its solubility and swelling in organic products. All of these factors are necessary for the material to withstand the action of organic solvents and deformation under constant stress, features of critical importance to proppants.

The manufacture of proppant particles is carried out by means of free radical copolymerization in aqueous suspension, using various types of peroxides, soluble in the organic phase and activated by heat, as free radical initiators. The organic mixture at the beginning of the copolymerization reaction contains, aside from the peroxides and free radicals resulting from the thermal decomposition thereof, at least three types of species exhibiting high reactivity to free-radicals: a) styrene double bonds, b) divinylbenzene double bonds (or other crosslinking agent) that reacts in the first place, and c) the remaining divinylbenzene (or other crosslinking agent) double bonds that generally do not react at the same rate as the first one, since their electronic structure and mobility are affected by the first reaction. As the reaction proceeds, the resulting molecules start to rapidly grow in size, thereby restricting the mobility of the whole system of reactants due to the increase in viscosity, and the reaction rates of all of the present species are affected, giving rise to the so-called diffusion-controlled reaction rate.

The viscosity of the system increases for two reasons: a) the increased size of the molecules produced by the reaction, and b) the increased glass transition temperature of the resulting solution. For significant reaction advancement, reaction rates can reach 0 when the glass transition temperature approaches (on the order of 10-20° C.) the temperature of the reaction mixture. The aforementioned patents slightly differ in the methods used to manufacture the products whose structures are described in a very elemental and synthetic manner. This is understandable, since modeling the structure resulting from a reaction involving so many species, wherein an important part of the process is controlled by the reaction rate controlled by the diffusion rate of the reactants, is extremely complicated, and would require excessive synthesis and analysis using tracers to identify structures, due to their heterogeneity. For practical purposes, said identification process can be replaced, at a much lower cost, by the experimental statistical optimization approach.

Depending on the crosslinking agent used and the reaction conditions, in these types of copolymerizations, wherein the reaction mixture consists of styrene, free radicals and low molecular weight crosslinkers with only two double bonds per molecule, a great variety of structures can be obtained, which in principle can be classified into two limiting classes:

a) A styrene reaction rate that is much higher than that of the crosslinking agents will produce polystyrene linear chain mixtures, at a higher rate at the beginning of the reaction, mixed with other highly crosslinked structures obtained after the styrene concentration has drastically decreased. This type of mixture will exhibit two glass transitions at different temperatures, and low resistance to “creep”. Furthermore, it will be soluble in many of the organic agents, such as those found in oil wells. Similar final results will be obtained in the opposite conditions, i.e. if the reaction rate for the crosslinkers is much higher than that of styrene.

b) If styrene and crosslinker reaction rates are similar, a more or less homogeneous branched structure will be obtained, whose characteristics will basically depend on the change in the reaction rate experienced by the crosslinking agent after the reaction of its first functional group, with only one glass transition, higher than that of the type a) product, good resistance to “creep” and less solubility in organic solvents.

If the crosslinkers contained in the reaction mixture contain high molecular weight species, such as the remaining double bonded polymers, there is a much wider variety of structures that can be obtained in the process, due to phase separation processes that may occur, which are mentioned and explained in further detail hereinafter.

Most of the relative improvements described in the aforementioned patents indirectly refer to methods that, in principle, would allow for better control of the evolution of the structure of the crosslinked copolymer.

U.S. Pat. No. 6,248,838 describes a method for reaction temperature programming which helps to maintain an approximately constant supply of free radicals, obtained from thermal decomposition of peroxides. It is argued that this supply at a constant rate should lead to constant polymerization rates and should cause the evolution of the molecular structure to follow a set path. This shall only be true at low conversion rates, and no longer applies as soon as the reaction rate control starts to be influenced by the diffusion rate of free radicals bonded to large molecules. The control of reaction rates via the diffusion rate of reacting free radicals has its best known example in the Tromsdorff effect: autoacceleration produced in styrene homopolymerization, which has been described in practically all of the textbooks on the subject. Technology for styrene production is heavily based on methods allowing high monomer conversions without the dangerous effects of autoacceleration. The method used to calculate the reaction temperature program is found in most specific textbooks since the 1950s. That is to say, this is public information known to experts in the art.

U.S. Pat. No. 6,248,838 also includes a number of crosslinking agents similar to divinylbenzene in that they contain at least two double bonds, and therefore exhibit bifunctional behavior in the copolymerization; however, they differ in the chemical structure binding both of the double bonds to each other. All of the aforementioned crosslinkers have two double bonds in their structure which can react with free radicals, bonded to each other via a carbon chain or, as in the case of divinylbenzene, a rigid bridge containing a benzene ring granting them a high glass transition temperature. It is the bond between the reacted double bonds that allows the formation of branches, and eventually an insoluble three-dimensional structure. These crosslinking agents have two double bonds in their structure and, because of the reasons explained hereinafter, do not lead to phase separation processes, as is the case for the present invention. Said patent includes some crosslinking agents with a more flexible structure (carbon chain bond between the double bonds) than divinylbenzene, which should reduce the change in the reaction rate of the double bond reacting in second place, but it does not provide detailed information with regards to this aspect of the copolymerization mechanism.

U.S. Pat. No. 8,278,373 includes a thermal treatment that, according to what is stated therein, should increase the glass transition temperature of the final product. The glass transition temperature will only increase if said thermal treatment makes the conversion rate of the remaining double bonds exceed the value obtained at the end of the copolymerization process. In order for this to happen, the reaction would have had to be slowed by a lack of mobility of the functional group, whether it is due to excessively slow diffusion or steric hindrance. Both effects can be reduced by increasing the temperature of the reaction. These concepts are also familiar to any expert in the art, as they have been included in specialized textbooks for many years.

U.S. Pat. No. 8,278,373 also includes the use of particle reinforcement to increase the effective Young's modulus of the styrene copolymers' three-dimensional lattice. The use of particles reinforcements and nano-reinforcements has been widely described in the public literature much prior to this patent.

Said U.S. Pat. No. 8,278,373 also includes the use of peroxides, which produce low molecular weight free radicals by thermal decomposition and, presumably, allow greater progress of the polymerization reaction at high conversions. This occurs because their smaller size promotes a higher diffusion rate, which in turn allows them to access double bonds, which at this stage of the process exhibit very low mobility, as in the case of the aforementioned second divinylbenzene double bond. The type of peroxide and the principle of greater mobility associated with the smaller size of the fragments resulting from thermal decomposition have been explicitly mentioned at least by the firm Atofina before the year 2000, as a comparative advantage over other products (see: http://www.luperox.com/export/sites/organicperoxide/.content/medias/downloads/literature/luperox-organic-peroxides-better-performance-in-suspension-polystyrene.pdf http://terpconnect.umd.edu/-choi/MSDS/Atofina/ORGANIC%20PEROXIDES.pdf)

The results mentioned in U.S. Pat. No. 6,248,838 and U.S. Pat. No. 8,278,373 represent the most important advances regarding the traditional art of copolymerization of styrene with divinylbenzene, since they attempt to improve the mechanical and structural properties of the final product.

The variants from the prior art discussed above refer to particles having a monolithic structure with only one glass phase at ambient temperature.

There are other offerings on the market, such as other particle systems to be used as proppants (e.g. refer to information found in http://www.dow.com/scripts/litorder.asp?filepath-liquidseps/pdfs/noreg/177-01732.pdf), also known as “Plastic Ball Bearings”. These systems based on technology derived from the production of the so-called ion-exchange resins consist of spherical particles exhibiting a copolymer structure of styrene with divinylbenzene, vitreous at ambient temperature, with homogeneously distributed microholes. These can withstand high acceptable non-reversible deformations, i.e. they are produced under plastic deformation regime. In the suspension polymerization process, reaction mixtures are added with specifically designed non-reacting solvents, which due to the relatively small size of their molecules, for similar reasons as those to be explained later on, produce domain segregation of non-reacting solvent at a nanometric scale, thereby increasing the acceptable deformation caused by generalized yield. These solvents can later be extracted from the particle to prevent a decrease in the glass transition temperature, leaving microholes in the glass matrix. This phase separation, a continuous glass phase with microholes, drastically decreases particle breakage in standard tests used to evaluate proppants, but necessarily reduces the Young's modulus values and increases deformation under pressure, thus limiting the range of acceptable pressure values for its use before compaction, which decreases the permeability of the particles be to unacceptable values.

### DESCRIPTION OF THE INVENTION

In light of the current state of the art, it will be very convenient to have access to new proppants with a higher concentration of covalent-bond bridges in the three-dimensional molecular lattice, to have a more favorable cost structure, with a wide range of structures contributing high Young's modulus values and capable of withstanding great deformation before breaking and the technology to balance costs and mechanical performance.

Therefore, an object of the present invention is to contribute a new technology that allows for production of nanocomposite particles, with low density and high modulus values, and capable of withstanding greater deformation before breaking. Breaking produces fine particles, which are highly undesirable, since they become trapped in the narrowest channels of the particle bed and decrease the permeability of said bed.

Another object of the present invention is to contribute high modulus, high tenacity synthetic nanocomposites in microparticle form with applications as low density synthetic proppants, which are especially useful in the unconventional oil and gas extraction processes known as “fracking”.

Another object of the present invention is to contribute a material in microparticle form with applications as torque reducers in the drilling of oil wells and other types of wells. An additional object of this invention is to contribute a fracture fluid comprising nanocomposite microparticles for unconventional oil and gas extraction processes.

A further object of the present invention is to contribute a material in microparticle form with applications in bearings for the sliding of heavy parts in the construction and mechanical industries.

Another object of the present invention is to contribute a process for the production of microparticle nanocomposites.

For a detailed description of the invention, it should be noted that the conceptual innovation of the present invention directly arises from the use of crosslinking agents with molecular structures much different from the classic ones described in the aforementioned patents. The classic molecular structure for crosslinking agents comprises only two double bonds, linked together by a more or less rigid carbon bridge, and in earlier technologies it consisted of a benzene ring, analogous to a styrene ring.

The crosslinking agents used in the present invention contain many double bonds within the same molecule, on the order of thousands of double bonds per crosslinking molecule, bonded together by carbon bridges. This type of molecular structure leads to a significant increase in the final bridge concentration in the three-dimensional molecular lattice, as it includes those existing prior to the copolymerization reaction. It also leads to the emergence of several inconvenient features that have been solved as detailed hereinafter, resulting in a technology capable of producing customized products.

The crosslinking agents used in this invention are diene homopolymers, copolymers, and terpolymers containing two double bonds per each 4 or 5 carbon atoms, with other monomers of the vinyl series. As a general rule, polymers of a different chemical nature are not miscible with each other, but they are soluble in small molecules. Following the above reasoning, styrene homopolymerization, a reaction comprising only styrene, would yield a homopolymer which would separate from the crosslinking agent in a different phase, resulting in a poor quality material, unless the eventual phase separation is controlled, thereby resulting in the copolymerization of styrene with the polymer used as crosslinking agent. Proper control of the copolymerization rate leads to a continuous vitreous phase with a high concentration of crosslinks, and to a separation into two phases (a continuous vitreous phase and a dispersed elastomeric phase) with domains of nanometric size, which provide the desired mechanical properties and tenacity. Therefore, the selection of the chemical composition and microstructure of the crosslinking agent must be combined with a proper reaction rate control. This also results in a more favorable cost structure and allows obtaining a wider range of structure yielding high Young's modulus values and allowing great deformation before breaking, due to phase separation increasing tenacity via generalized yield.

The production of low density synthetic proppants is based on the copolymerization of styrene drops suspended in an aqueous medium. The size and shape of styrene drops are stabilized through gentle stirring of the medium, in conjunction with an adequate amount of an agent that acts as a surfactant, since it contains some hydrophilic and some hydrophobic regions in the same molecule. The geometric arrangement of the water-styrene-surfactant system associated with the minimum potential energy state corresponds to a film of surfactant agent coating the drops of organic material dispersed in the water having a spherical shape due to the minimum surface area to volume ratio of a sphere. The water suspension system also contributes a system for division of the reaction mass into spherical particles of a controlled size and the adequate rate and heat transmission capacity necessary to precisely control particle temperature and avoid overheating, which would deviate from the path designed and planned for the copolymerization reaction.

Styrene polymerization is initiated and terminated by free radicals generated within the drops (future particles) by means of the thermal decomposition of the soluble peroxides in the organic liquid thereof. The free radicals react with the double bonds of styrene and of the crosslinking reactants, thereby transforming the mixture of styrene and crosslinking polymer molecules into a profusely branched and crosslinked polystyrene three-dimensional structure. Crosslinking agents have at least two bifunctional reactive sites, which do not normally react at the same rate and temperature. In general, it can be observed that crosslinking agents with more reactive sites per molecule result in better mechanical properties in the product, particularly higher glass transition temperature values and acceptable elastic deformation, due to the higher concentration of bonds in the three-dimensional lattice of the molecule. The glass transition temperature is the temperature at which the Young's modulus value of an amorphous polymer decreases by a factor varying between 2 and 3 orders of magnitude.

More specifically, the process for manufacturing the microparticle nanocomposites of the present invention involves suspension copolymerization, in an aqueous medium, of styrene drops containing the dissolved crosslinking agents that have at least two bifunctional reactive sites, through the production of free radicals by means thermal decomposition of peroxide, controlling the balance of styrene and crosslinking agent stoichiometry and the progression of reaction temperatures. The crosslinking agents used were mixtures of copolymers of butadiene, isoprene and other dienes, plus variable ratios of divinylbenzene. The stoichiometric ratios of styrene double bonds to crosslinking agent double bonds ranged from 3 to 60 styrene double bonds per crosslinker double bond in the original reaction mixture. Reaction temperatures were programmed in ascending slopes and varied from 65° C. to 170° C., in order to achieve the maximum possible conversion. The maximum possible temperatures of the process were 250° C., preferably within the aforementioned range (65° C. to 170° C.).

To achieve the optimal properties of the final particle, the reaction system must be adequately balanced in its stoichiometry and its temperature program, which is directly related to the types of peroxides included in the formulation. During the course of the reactions in the reactor, each drop must contain an adequate concentration of free radicals, and styrene and crosslinking agents must be available and accessible to the free radicals. Very high concentrations of free radicals lead to the elimination of a fraction thereof, due to their high reactivity; very low concentrations lead to slow polymerization and crosslinking rates, resulting in unwanted changes in the final structure of the solid.

The present invention describes the use of a crosslinking reactant system specifically designed to achieve a more efficient polystyrene crosslinking reaction in a variety of polymerization procedures, to improve the rigidity, tenacity, maximum possible operational temperature, resistance to solvents and to the environment of spherical styrene copolymer particles. The system of crosslinking reactants has been designed meet several requirements (including achieving the maximum possible chemical crosslinking density and the maximum possible degree of chemical reaction advancement) and polymerization statistics that allow an adequate solubility in the styrene-polystyrene mixture, without decreasing the glass transition temperature of the final product.

This invention also shows the use of a system of peroxides as free radical initiators at a wide range of temperatures in a styrene polymerization and crosslinking process. The types and relative concentrations of peroxides to be used are specifically designed to maximize the efficiency of the reaction of free radicals with styrene and its crosslinkers.

Proppants manufactured according to this invention must meet at least two basic requirements:

a) High Young's modulus values, to prevent the deformation caused by high pressure from obstructing of the space for fluids to flow through the randomly packed spheres, and
b) High acceptable deformation values, to minimize sphere breakage, which may produce smaller particles, which would be carried by the fluid and eventually become trapped in the narrowest spaces for fluids to flow, thus reducing the permeability of the porous bed.

The molecular structures of classic crosslinking agents, including those from the aforementioned patents, exhibit two reactive sites for free radicals, consisting of two double bonds connected by an organic bridge, which in the case of divinylbenzene is a benzene ring.

The present invention describes the use of crosslinking agents having large quantities of double bonds in their molecular structure, on the order of thousands per molecule, with an average concentration estimated to be on the order of one for every three carbon atoms along each main chain, bonded by organic bridges with covalent bonds.

Diagram 1 shows a sketch of the molecular structure produced by the reaction of several molecules of styrene with divinylbenzene, as an example of styrene copolymerization with a crosslinking agent containing only two double bonds in its original molecule (in this case, divinylbenzene).

Secondary carbon atoms of the original double bonds that were transformed into tertiary carbon atoms in the copolymerization process are bolded in larger font for ease of reading. The 4 wavy lines present in the final structure indicate the presence of 4 polystyrene chains at the end of the polymerization process, bonded to the bridge produced by the divinylbenzene molecule.

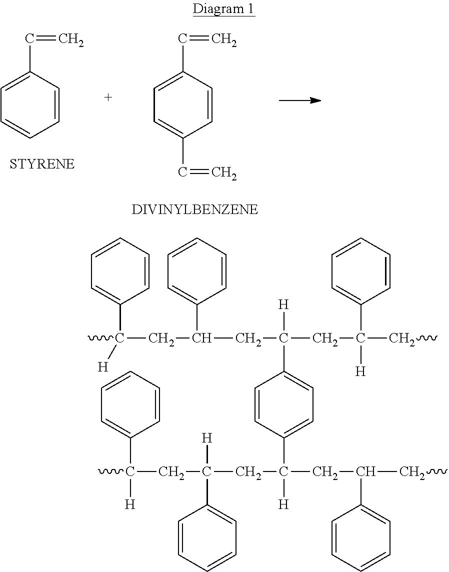

Diagram 2 shows an example of the molecular structure produced by the reaction of several styrene molecules with a region of the macromolecule of a crosslinking agent which is a butadiene-isoprene copolymer. It can be observed that apart from the two remaining chain regions of the original copolymer chain, depicted as zigzag lines, 6 additional chains are obtained at the end of the reaction, depicted as wavy lines, which are bonded to the original double bond group.

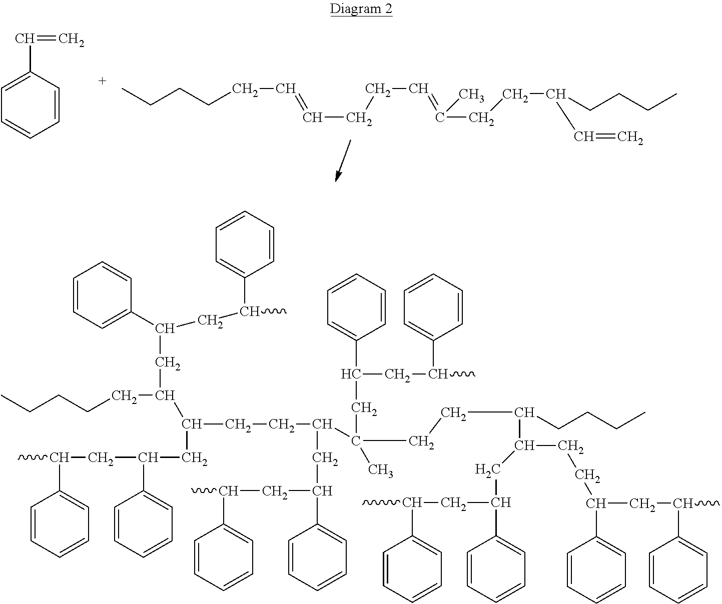

It should be noted that a complete reaction is assumed in both reaction Diagrams 1 and 2, since the products can only be obtained in polymerizations where the reaction temperature is considerably higher than the glass transition temperature of the reaction mixture. The crosslinker used in Diagram 1 results in a final structure having 4 polystyrene chains bonded to the 10 carbon atoms contained in the original crosslinker molecule. The crosslinker used in Diagram 2 results in a final structure having 8 polystyrene chains bonded to the group of 12 carbon atoms contained in the original crosslinker molecule. The higher ratio of chains bonded per carbon atom of the crosslinking group leads to a higher concentration of elastically active chains in the product of the present invention, which necessarily leads to higher modulus values and tenacity.

The materials used in the present invention as crosslinking agents are polymers, due to their size and molecular structure, more specifically, homopolymers, copolymers and terpolymers of isoprene, butadiene and of other dienes, in their block, statistical (random) and intermediate forms, in a wide range of molecular weights ranging from 1000 to 300000 dalton, with linear and branched structures, and mixtures of thereof. Included as comonomers, apart from isoprene and butadiene, are other dienes and all monomers known as vinyls (styrene, alpha-methyl-styrene, and divinylbenzene), acrylics, ethylene, propylene and acrylonitrile. The crosslinking agents also include the partially hydrogenated versions of homopolymers and copolymers of isoprene, butadiene and other dienes, as well as all monomers known as vinyls (styrene, alpha-methyl-styrene), acrylics, ethylene, propylene and acrylonitrile. The crosslinking agents also include mixtures of divinylbenzene with copolymers and terpolymers of butadiene, isoprene and other aforementioned dienes.

One advantage of using the type of crosslinking agents of the present invention arises from the fact that using divinylbenzene as crosslinker yields a double bond concentration of two for every six carbon atoms of the benzene ring. However, by using the type of crosslinkers proposed in the present invention, the concentration of double bonds will be on the order of up to two for every three carbon atoms, with a more probable estimated average of two for every four carbon atoms, thus allowing for the production of a more compact three-dimensional lattice molecular structure.

Another advantage of the present invention is derived from the fact that for bifunctional crosslinkers such as divinylbenzene, each double bond is initially bonded to only one other one before the copolymerization process. In the case of the type of crosslinker of the present invention, each double bond is initially bonded to at least two others, thus increasing the original bond density for the future three-dimensional lattice, since the reaction of each double bond yields a new bond, in addition to the initially present bonds.

A possible drawback arising in these systems, deriving from the use of polymers as crosslinkers, has already been mentioned in describing the structures that can be obtained as mixtures of branched and linear species that are not covalently bonded to each other. Normally, as described by the Flory-Huggins theory widely confirmed experimentally in the literature, polymers of different chemical species having molecular weights above a certain limit (varying between chemical species but being generally low) are not miscible with each other; this rule has very few exceptions. When the set of chemical species present in a reaction system containing polymers leads to the production of a second type of polymers, if these do not chemically bond to the first type, a phase separation occurs, which can often be observed macroscopically. The system of reactants included in the copolymerization, used for the inclusion of polymers as crosslinking agents, has been designed to allow for an early reaction of a considerable proportion of the double bonds covalently bonded to the main chain thereof, thus partially or totally controlling the aforementioned phase separation according to the desired type of product.

The Flory-Huggins theory describes the thermodynamic trend for the progress of mixing and phase separation processes as a sum of the effects of the changes in entropy and enthalpy of the system as a whole. The applicable form of the Flory-Huggins theory to describe the transition between miscibility and phase separation of two types of chemically different species polymers is:

$$Δ G = RT \{ ( \frac{{φ}_{1}}{{N}_{1}} ) ln {φ}_{1} + ( \frac{{φ}_{2}}{{N}_{2}} ) ln {φ}_{2} + {χφ}_{1} {φ}_{2} \}$$

### Where:

ΔG the free energy change associated with the process of mixing (or separating) two species, 1 and 2. In this case, we take styrene as species 1, which is transformed into a polymer, and the polymer used as a crosslinker as species 2, without attaching any importance to the fact that many of these polymers are actually copolymers from two different chemical species.

φ₁ is the initial volume fraction for styrene molecules, which are transformed into a polymer during the copolymerization process. The well-known volume contraction produced by the polymerization reaction is not taken into account in this qualitative explanation, and the value of φ₁ is considered to be constant throughout the process.

φ_{2□} is the volume fraction for the polymer used as a crosslinker, which is considered to be constant for the sake of simplicity. Obviously, φ_{1□}φ_{2□}=1=constant.

N₁ and N₂ are the average degrees of polymerization for each species.

χ is the parameter that defines the mixing enthalpy of the solution, that is, the amount of heat exchanged in the mixing process, which normally takes on small positive values as long as species 1 and 2 are chemically different, and in this particular case will depend on the chemical composition of the polymer used as a crosslinker and on its molecular architecture. This parameter is very difficult measure with precision in experiments.

The first two terms on the right side describe the changes in entropy of the system produced when the volume fractions species 1 and 2 are changed, or when the number of cells occupied by any monomer (1 or 2) is forced to share neighboring cells with another monomer of its species due to chemical bonding, as is the case in polymerizations, thus changing the values of N₁ and N₂.

Negative values of ΔG indicate that the mixing process is associated with a decrease in the free energy of the system, and therefore predict that the two species will mix and remain as a stable and homogeneous solution.

Positive values of ΔG indicate that mixing will not occur, or if forced, only dispersion with macroscopic phase separation will be achieved.

In the system of interest, wherein styrene initially dissolves the crosslinking polymer, even though values of χ are not favorable for dissolution (i.e. positive but small), the weight of the term

$$( \frac{{φ}_{1}}{{N}_{1}} ) ln {φ}_{1}$$

where the value of N₁ is initially N₁=1 causes the term ΔG to be initially negative, as corresponds to a homogeneous solution. Since one of the species (1) is acting as a polymer solvent and is polymerizing, the value of N₁ will increase, thus decreasing the absolute value of the term

$$( \frac{{φ}_{1}}{{N}_{1}} ) ln {φ}_{1}$$

and causing the values of ΔG to change from negative to positive, thus indicating that the mixture will destabilize and start to separate into phases. If during styrene polymerization, the dissolved polymer reacts with forming molecules, producing a three-dimensional lattice, the process of phase separation will be hindered by the covalent chemical bonds between molecules that were previously two different species and which then become only a single species. Thus, the phase separation process is guaranteed to be practically “customizable”, by selecting χ values by means of the chemical composition and molecular architecture of the crosslinking polymer, and the moment of phase separation initiation by means of the reactivity of the double bonds present in the polymer used as crosslinker (this initiation moment is an advance in the polymerization reaction). χ values more favorable for mixing will initiate phase separation in more advanced reaction advancements, and vice versa.

At the beginning of the reaction, since the copolymerization reaction rate will be controlled by the concentration of double bonds and free radicals in the medium, it can be asserted that for a given formulation (a mixture of styrene and crosslinking agents, with their respective initial values of φ₁, φ₂, χ, N1 and N2), the reaction rate can be controlled by combinations of concentrations of peroxides and temperature programs.

A controlled phase separation process allows for design of the final properties of the product. The separation of a fraction of a lower modulus (elastomeric) material as a micro phase, up to 15% by volume, preferably between 0.5% and 8%, allows for increased tenacity (an increase in the acceptable deformation before breaking) via generalized yield. Microseparation also allows for more efficient control of the mechanically measured glass transition temperature, since by not separating into phases, the elastomer produces a decrease in the glass transition temperature of the continuous phase, as detailed in copolymerization theories. This fact explains the advantage of using copolymers not having only double bonds, in order to delay the immobilization moment of the crosslinking polymer as needed, allowing only phase separation of very small domains, on the order of 1000 Å, so as to not decrease the glass transition temperature of the continuous phase, but nonetheless still increasing the tenacity of the continuous phase as detailed above.

The combination of the choice of crosslinking polymer type to be used and the type of peroxide, together with an adequate reaction temperature program, allows a proper balance of high volumetric bond concentration in the three-dimensional lattice with a microphase separation with volume fractions and sizes convenient for the desired balance of properties, as described hereinbefore.

This invention is better illustrated by the following examples, which are not to be interpreted as limits of the scope of the present invention. On the contrary, it must be clearly understood that after having read the present description, persons skilled in the art can make use of other embodiments, modifications and equivalents of the present invention without straying from the spirit thereof and/or the scope of its annexed claims.

### BRIEF DESCRIPTION OF THE FIGURES

FIG. 1 shows a photograph of the particles from the prior art, after being subjected to pressure deformation tests;

FIG. 2 shows an enlarged view of the particles from the prior art after being subjected to pressure deformation tests;

FIG. 3 shows a 60× magnification of the particles of the present invention;

FIG. 4 shows a photograph of the particles of the present invention after being subjected to pressure deformation tests;

FIG. 5 shows another photograph of the particles of the present invention after being subjected to pressure deformation tests;

FIG. 6 shows the measurements of the shear modulus values as a function of the temperature; and finally,

FIG. 7 shows the change in enthalpy values as a function of the temperature.

### EMBODIMENTS OF THE INVENTION

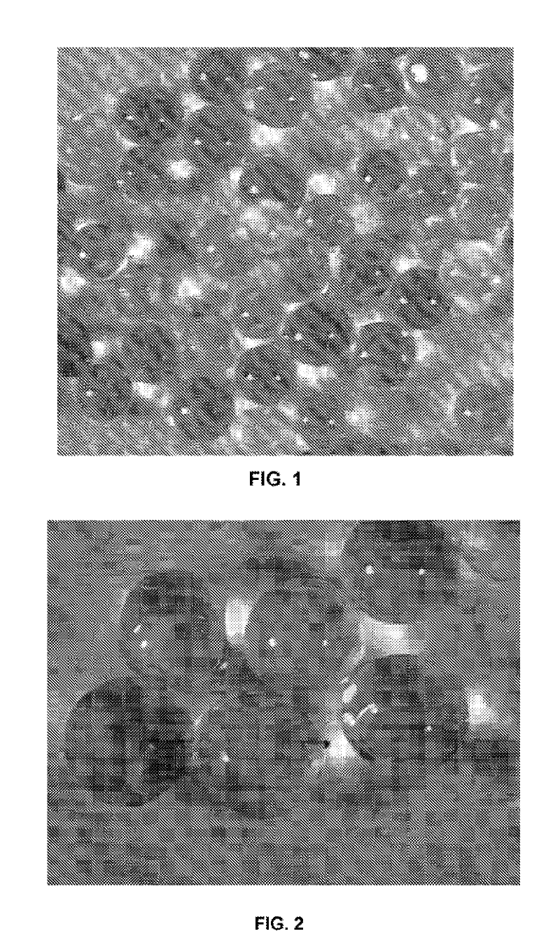

In a more detailed description of the figures, it can be observed that FIG. 1 shows a photograph of particles from the prior art, after being subjected to pressure deformation, in which said particles, having a diameter of 0.45 mm, were subjected to “Crush Tests” (API 19C RP Standard, at pressures of 8,000 psi=551.7 Bar). The presence of non-recovered net spherical collapses produced by the force exerted by neighboring particles can be clearly observed.

FIG. 2 shows an enlarged view of particles from the prior art with a diameter of about 0.45 mm, after being subjected to pressure deformation. Tests were of the “Crush Test” type (API 19C RP Standard, at a pressure of 10,000 psi=689.6 Bar). Said particles clearly show the presence of more non-recovered net spherical collapses than those shown in FIG. 1, due to the force exerted by neighboring particles.

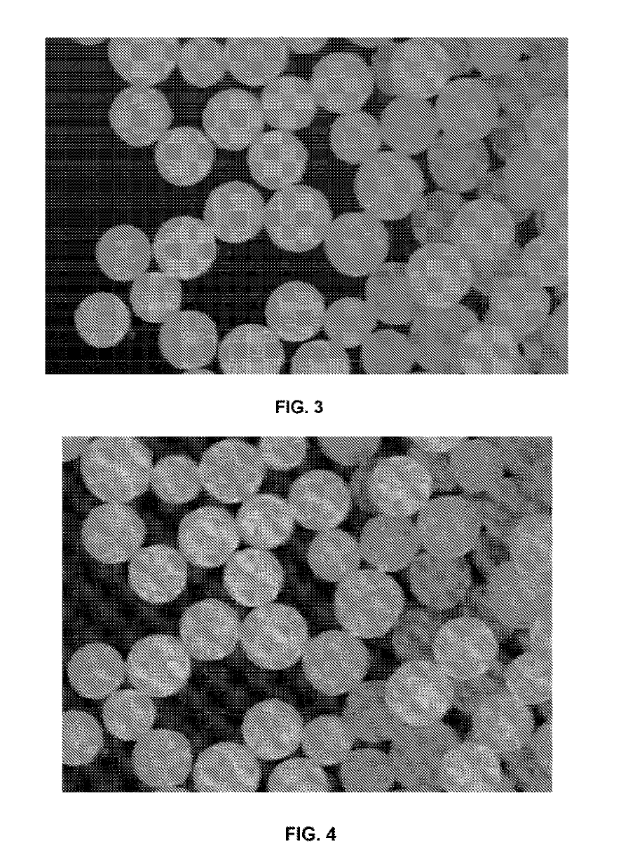

FIG. 3 shows a 60× magnified microscope photograph containing the particles of the present invention.

FIG. 4 shows a photograph of the particles of the present invention, after being subjected to pressure deformation in a “Crush Test” (API 19C RP Standard, at a pressure of 10,000 psi=689.6 Bar), where the deformation produced by the force exerted by nearby particles can be clearly seen. In this case, said deformation does not consist of net spherical collapses, but instead is partially recovered.

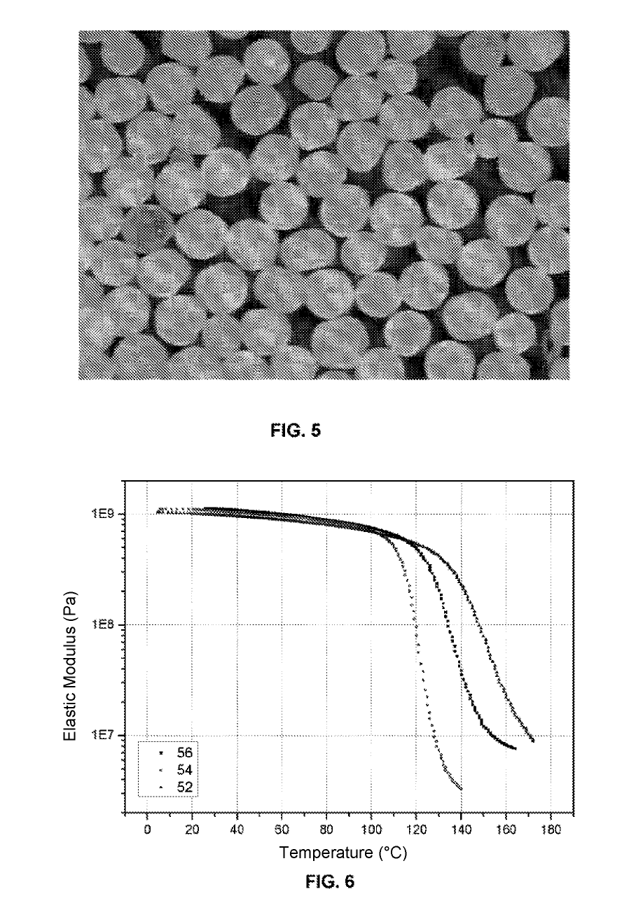

FIG. 5 shows a photograph of the particles of the present invention, after being subjected to pressure deformation in a “Crush Test” (API 19C RP Standard, at a pressure of 12,000 psi=827.6 Bar), where the deformation produced by the force exerted by nearby particles can also be clearly seen. In this case, said deformation does not consist of net spherical collapses either, but instead is partially recovered.

FIG. 6 shows the measurements of the shear modulus values as a function of the temperature. The glass transition temperature is calculated as the temperature where the abrupt drop in modulus values begins.

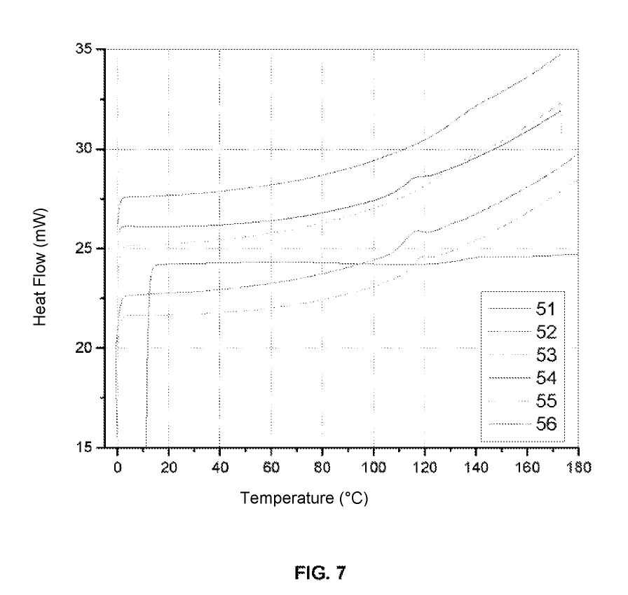

FIG. 7 shows the change in enthalpy values as a function of the temperature. The glass transition temperature is calculated as the half-way point between the abrupt spike in enthalpy change values. The values calculated from modulus measurements and calorimetry coincide closely.

FIGS. 1 and 2 show photographs of particles from the prior art, of a diameter of around 0.45 mm, after being subjected to a “Crush Test” (API 19C RP Standard, at pressures of 8,000 and 10,000 psi=551.8 and 689.6 Bar) where the non-recovered net spherical collapses produced by the force exerted by nearby particles can be clearly seen.

In the case of the present invention, a process of polymer-polymer phase separation, controlled in order to obtain a continuous vitreous phase and an elastomeric phase in domains of nanometric size with an elastomer volume percentage of up to 15%, preferably between 0.5 and 8%, allowing for a considerable increase in the capacity to withstand acceptable deformation without breaking, but since the separate elastomeric phase remains covalently bonded to the continuous matrix, the potential decrease in Young's modulus values is significantly lower, and a high percentage of the deformations produced in the “Crush Test” (API 19C RP Standard) are recoverable. FIGS. 4 and 5 show photographs of particles of the present invention, of a diameter of around 0.45 mm, after being subjected to a “Crush Test” (API 19C RP Standard, at pressures of 10,000 and 12,000 psi=689.6 and 827.6 Bar) where the deformation produced by the force exerted by nearby particles can be clearly seen, which does not consist of net spherical collapses, but instead is partially recovered.

Styrene solutions of copolymers of isoprene and styrene, of butadiene and styrene, and of isoprene, butadiene and styrene were used. In these copolymers, both butadiene and isoprene contributed residual double bonds, which reacted in the crosslinking process at different rates according to their electronic structure and steric hindrance. Copolymerized styrene reduced the magnitude of the positive values of the χ parameter of the Flory-Huggins equation, and, since it does not have any available double bond to react as crosslinker, reduced the global reaction rate of the crosslinker, thus delaying to some extent the starting moment of the phase separation, with the aforementioned purpose. χ values for each crosslinking styrene-copolymer pair were not measured experimentally, as the effect of the change in N₁ during the reaction rapidly cancels out any difference between the copolymers used. A qualitative evaluation of the clarity of the solution of copolymer in styrene was used instead; those types of copolymers whose 10% solutions in styrene at ambient temperature showed turbidity were ruled out. The proportion ranges of styrene in the copolymer used varied between 15% and 48%, and the proportion ranges of isoprene and butadiene varied between 12% and 85%. Random and block copolymers, with linear and branched structures, were used. The solvent in every case was styrene with a proportion of divinylbenzene between 2% and 15%. The crosslinking copolymer concentration varied between 2 and 15%. The peroxides used were chosen according to their temperature ranges corresponding to half-life values of 6 minutes and 60 minutes, in order to be able to estimate reaction rates and the possibility of autoacceleration of the reaction system. Temperature ranges corresponding to those 60 minute half-life values varied between 85° C. and 152° C.

A) The formulations for the production of proppant particles were designed following the basic qualitative rules detailed above. A multivariate statistical optimization system was used. In these optimization systems, the effects that different variables have on the final properties of interest are experimentally explored by means of small changes in the concentrations and types of reactants used in the formulation, and in the values of the parameters that define the process, such as temperatures and reaction times, the volumetric ratio between water and the organic phase of the suspension, height to diameter ratio of the suspension polymerization reactor, size, number and placement of baffles, size, number and placement of stirring blades, and speed and intensity of the stirring. The ranges of values over which these parameters are varied are chosen based on the experimental results published in the public literature by other authors and on the previous experience of the directors of the project. The optimum combination from among that group of values was chosen for the different variables. The process can be repeated more than once if a satisfactory combination is not achieved, thus further limiting the field of exploration in each case. This optimization method is a standard procedure for experts in the art versed in statistical methods, and was described in detail and with examples in the book Statistics for Experimenters—Design, Innovation and Discovery” (Box, Hunter & Hunter), Wiley, Interscience (Second Edition) (2005) under the title “Fractional Factorial Design”.

B) To test the different formulations developed to date, over fifty combinations of peroxides, crosslinking agents and temperature programs were used, as shown in the following table:

| | | | % | % | % | % | % | | |
|---|---|---|---|---|---|---|---|---|---|
| Polybutadiene | | | of | Perox. | Perox. | Perox. | Perox. | Tg | |
| type | % | # | DVB | #1 | #2 | #3 | #4 | (° C.) | G* (MPa) |
| N/A | 0 | 1 | 0 | 0.20% | — | 0.30% | | — | — |
| N/A | 0 | 2 | 5 | | | | | 132 | 723.5 ± 16.5 |
| N/A | 0 | 3 | 10 | | | | | 126 ± 6 | 839.5 ± 28.5 |
| N/A | 0 | 4 | 0 | 0.20% | 0.60% | — | | 100 | 332 ± 23 |
| N/A | 0 | 5 | 5 | | | | | 118 ± 4 | 605.55 ± 72.5 |
| N/A | 0 | 6 | 10 | | | | | 130 | 623.5 ± 47.5 |
| N/A | 0 | 7 | 0 | 0.20% | — | 0.30% | | — | — |
| N/A | 0 | 8 | 5 | | | | | 120 | 770 ± 10 |
| N/A | 0 | 9 | 10 | | | | | 127 | 760 ± 100 |
| N/A | 0 | 10 | 0 | 0.20% | 0.60% | — | | — | — |
| N/A | 0 | 11 | 5 | | | | | 115 | 780 |
| N/A | 0 | 12 | 10 | | | | | 130 ± 3 | 900 ± 50 |
| 1 | 5 | 13 | 0 | 0.20% | 0.30% | — | | 97.5 | 835.2 |
| 1 | 5 | 14 | 0 | | | | | 98.6 | 368.5 |
| 1 | 5 | 15 | 3 | | | | | 111.82 | 847.2 |
| 1 | 5 | 16 | 3 | | | | | 111.82 | 720.7 |
| 2 | 5 | 17 | 0 | 0.20% | 0.30% | — | | 101.19 | 835.2 |
| 2 | 5 | 18 | 0 | | | | | 106.15 | 652.2 |
| 2 | 5 | 19 | 3 | | | | | 112.22 | 674.3 |
| 2 | 5 | 20 | 3 | | | | | 115.03 | 940.7 |
| 3 | 5 | 21 | 0 | 0.20% | 0.30% | — | | 100.79 | 884.3 |
| 3 | 5 | 22 | 0 | | | | | 101.22 | 413.1 |
| 3 | 5 | 23 | 3 | | | | | 114.58 | 815.6 |
| 3 | 5 | 24 | 3 | | | | | 114.58 | 839.2 |
| 1 | 5 | 26 | 0 | 0.20% | 0.30% | — | | 102.64 | 823.4 |
| 1 | 5 | 27 | 3 | | | | | 105.72 | 954.2 |
| 2 | 5 | 28 | 0 | 0.20% | 0.30% | — | | 103.47 | 918.6 |
| 2 | 5 | 29 | 3 | | | | | 112.46 | 1154.23 |
| 3 | 5 | 30 | 0 | 0.20% | 0.30% | — | | 113.05 | 823.4 |
| 3 | 5 | 31 | 3 | | | | | 112.75 | 954.2 |
| 1 | 5 | 32 | 0 | 0.20% | 0.30% | 0.30% | | 101.6 | 976.8 |
| 1 | 5 | 33 | 3 | | | | | 113.23 | 964.7 |
| 2 | 5 | 34 | 0 | 0.20% | 0.30% | 0.30% | | 102.2 | 976.8 |
| 2 | 5 | 35 | 3 | | | | | 113.02 | 909.5 |
| 3 | 5 | 36 | 0 | 0.20% | 0.30% | 0.30% | | 100 | 796.3 |
| 3 | 5 | 37 | 3 | | | | | 111.6 | 785.1 |
| 3 | 3 | 38 | 0 | 0.30% | 0.30% | 0.30% | | 98.2 | 823 |
| 3 | 6 | 39 | 0 | 0.30% | 0.30% | 0.30% | | 97.6 | 872 |
| 3 | 9 | 40 | 0 | 0.30% | 0.30% | 0.30% | | 97.2 | 1026 |
| 5 | 3 | 41 | 0 | 0.30% | 0.30% | 0.30% | | 98.3 | 941 |
| 5 | 6 | 42 | 0 | 0.30% | 0.30% | 0.30% | | 97.4 | — |
| 5 | 9 | 43 | 0 | 0.30% | 0.30% | 0.30% | | 99.1 | — |
| 3 | 5 | 44 | 0 | 0.3% | 0.3% | 0.3% | 0.3% | 94.3 | — |
| 3 | 5 | 45 | | | | 0.3% | 0.50% | 96.7 | — |
| 3 | 5 | 46 | | | | 0.3% | 0.30% | 97 | — |
| 3 | 5 | 47 | 0 | 0.20% | | 0.3% | 0.30% | 98.9 | — |
| 3 | 5 | 48 | | | 0.3% | 0.30% | | 99.1 | — |
| 3 | 5 | 49 | 0 | 0.20% | | 0.3% | 0.30% | 101.3 | — |
| 3 | 5 | 50 | | | 0.3% B | 0.30% | | 99.7 | |
| 3 | 5 | 57 | 3% | 0.20% | 0.3% B | — | | 110.5 | 1030 |
| 3 | 5 | 58 | | 0.20% | — | 0.30% | | 110.4 | 1150 |
| 3 | 5 | 59 | | 0.20% | 0.3% | 0.30% | 0.30% | 106.4 | 1090 |
| 3 | 5 | 60 | | 0.20% | | 0.3% | 0.30% | 108.6 | 1040 |
| 3 | 5 | 61 | | — | | 0.3% | 0.30% | 111.7 | 925 |

C) For each formulation, several cylindrical samples (6 mm in diameter and 80 mm in length) were produced in glass tubes with 0.5 mm wall thickness. This method allowed for the labor-intensive system of setting up a complete suspension polymerization for each of the formulations and conditions of the process to be tested to be discarded, along with the associated cost and work it entails, and allows for use of only one reactor to simultaneously test polymerizations with different formulations (up to 1 per tube; up to a high number of tubes depending on the diameter of the reactor used), with a group of shared process parameter values for all of the formulations tested in this set. Since polymerization in these tubes must be equivalent to the industrial suspension process, and since the suspension process can be modeled as a group of small mass polymerization reactors (suspended in a medium providing very efficient heat transfer for an adequate temperature control), the requirements to be met by this tube polymerization system are that the ratio of the external area of the tube to the reacting mass volume is sufficiently high, and that the temperature difference between the center of the reacting cylindrical mass and the internal surface of the glass tube is no more than 3° C. The temperature difference between the center of the reacting cylindrical mass and the internal surface of the glass tube was calculated based on the reaction heat that has to be evacuated, with satisfactory results for these dimensions. Various diameters and numbers of glass tubes were tested in a water bath within a reactor with temperature and atmosphere control, until an operational zone with an adequate combination of sample size and efficient temperature control was determined, the parameter of interest in this case being the heating and cooling capacity of the reactor. Some of the formulations polymerized in glass tubes were also polymerized in suspension, in identical process conditions, yielding physical property results (Young's modulus and glass transition temperature) very similar to those measured in the samples polymerized in glass tubes.

Table 1 shows the modulus value results obtained through measurements performed on samples polymerized in glass tubes and in suspension. PB IV is a copolymer of butadiene and DVB is divinylbenzene.

TABLE 1

| | | | | | | Modulus of |
|---|---|---|---|---|---|---|
| | Styrene | PB IV | DVB | Perox. | Modulus of in glass | suspension |
| | % in | % in | % in | % in | polymerization | polymerization |
| Formulation | weight | weight | weight | weight | (GPa) | (GPa) |
| A | 100 | 0 | 0 | 0.2 | 3.1 | 3.1 |
| B | 91 | 6 | 3 | 0.2 | 3.0 | 2.95 |
| C | 85 | 12 | 3 | 0.2 | 2.55 | 2.7 |

D) Cylindrical samples are very useful in rapidly and precisely measuring values for Young's modulus and glass transition temperatures in a mechanical spectrometer with temperature control. The mechanical spectrometer, Anton-Paar model Physica II, consists of two coaxial axes ending in cylindrical clamps with adjustable conic nozzles that accept cylindrical samples from both ends. One of the axes is connected to the electric motor that applies and measures torque, and precisely measures the angular deformation as rotation of one of said coaxial axes. The system is contained within a chamber with temperature control by means of forced nitrogen convection. The shear modulus versus temperature graphs allow for calculation of the glass transition temperature as well. FIG. 6 shows the results of measurements performed with the mechanical spectrometer on cylindrical samples of some formulations differing in their glass transition temperatures. FIG. 7 shows enthalpy versus temperature characteristic curves, measured by a differential scanning calorimeter, for several formulations. Glass transition temperature values corresponding to formulations 52, 54 and 56, measured using both methods, showed a high coincidence.

E) For some formulations, Young's modulus values were also measured by means of a Hysitron brand nanoindenter (TI-950 Triboindenter), running at ambient temperature. These values coincided very well with the values measured by said mechanical spectrometer in point D). The nanoindenter does not have temperature control nor does it allow for the glass transition temperature to be estimated, but it is useful in measuring some mechanical properties, such as Young's modulus, directly on particles produced in suspension. There is no other available instrument capable of measuring mechanical properties in samples this small.

F) Enthalpy versus temperature characteristic curves for several samples were measured in a Perkin-Elmer Pyris II Differential Scanning calorimeter (DSC) in order to calculate the glass transition temperature in standard form, such as the average increase in specific heat capacity, and compare it with the results obtained by the mechanical spectrometer. The results showed high coincidence. This verification is necessary to verify whether the products obtained by glass tube polymerization are identical in behavior to those obtained via suspension polymerization. Some results are included in FIGS. 6 and 7 described above in point D) of this section.

G) Glass transition temperature values were also measured indirectly for particles obtained through suspension polymerization, by means of the mechanical spectrometer. For selected formulations, particles were included in a high glass transition temperature crosslinked homopolymer epoxy plate; the plate was subjected to a torsion test in the mechanical spectrometer, yielding modulus versus temperature curves. These curves show two drops in the modulus values: one corresponding to the epoxy resin and the other corresponding to particles polymerized in suspension. The glass transition temperature of the epoxy resin was measured in another similar plate without added particles.

H) Spherical particles of selected formulations produced in a pressurized stainless steel reactor equipped with stirring means and temperature control. The reactor has a 3 liter capacity, a hermetic lid with O-rings, pressurization and vent valves, thermocouple for measurement and temperature control which is submerged in the liquid, and a vertical shaft with blades specifically designed to lightly and evenly stir the whole liquid contained within it. It also has a system of vertical baffles. The group of baffles and stirring blades were experimentally tested in a glass container of similar dimensions to those of the reactor, to verify vertical recirculation of water and styrene solution with crosslinking polymer, in order to program the most convenient shaft rotation regimen to control the size of the particles to be produced. Reactor temperature is efficiently controlled by means of a system of band-type stainless steel heaters, powered by a PID control system based on the aforementioned thermocouple readings. Reactor refrigeration is solely carried out by free convection from its external surface.

I) Size distributions of the particles produced in the suspension reactor range from 0.1 mm to 3 mm. Particles in the range of proper size to be used as proppants were obtained by means of normalized sifting, using the fractions obtained between sieves 20/40 and 50/70 for the assays.

J) Particles selected by sifting were subjected to a compression test (Crush Test) (ISO 13503 Standard, API RP19C).

K) Particles were photographed after the compression test. FIGS. 4 and 5 show photographs of particles manufactured according to the procedure described in this invention after being subjected to a “Crush Test” (API 19C RP Standard) at pressures of 10,000 and 12,000 psi=689.6 and 827.6 Bar, respectively.

1. Synthetic nanocomposites in microparticle form formulated from polybutadienes, and other polydienes, capable of withstanding great deformation before breaking, with applications in diverse fields of industry, especially in the preparation of low density synthetic proppants to be used in unconventional oil and gas extraction processes (fracking), in bearings for the slide of very heavy parts in the construction and mechanical industries, in torque reducers for the drilling of oil wells and other types of wells, characterized by the fact that said microparticle nanocomposites exhibit a continuous glass phase with separation of other phases, which entail high Young's modulus values and an increase in their acceptable deformation of up to 40%.

2. The process for production of the nanocomposite particles of claim 1, comprising: suspension copolymerization in an aqueous medium of styrene drops containing crosslinking agents dissolved in said drops and having at least two bifunctional reactive sites; generating free radicals by means of peroxide thermal decomposition, with control of the stoichiometry of styrene and crosslinking agent and of the progression of reaction temperatures; the stoichiometric ratios of styrene double bonds to crosslinking agent double bonds ranging from 3 to 60 styrene double bonds per each crosslinker double bond in the original reaction mixture; and the reaction temperatures being in ascending slopes between 65° C. and 250° C.

3. The process of claim 2, characterized by the fact that the crosslinking agents are homopolymers and copolymers of isoprene, butadiene and other dienes.

4. The process according to any of claim 2 or 3, characterized by the fact that the homopolymers and copolymers of isoprene, butadiene and other dienes include molecular structures in block, statistical (random) and intermediate forms, in a wide range of molecular weights, with linear and branched structures, and mixtures thereof.

5. The process according to any of claim 2, 3 or 4, characterized by the fact that the comonomers of isoprene, butadiene and other dienes are selected from styrene, alpha-methyl-styrene, acrylic and methacrylic comonomers, ethylene, polypropylene and acrylonitrile, including their various partially hydrogenated versions.

6. Low density synthetic proppants comprising the microparticle nanocomposites from claim 1, wherein said proppants:
a) have high Young's modulus values; and
b) also have high acceptable deformation values of more than 40%.

7. Fracture fluid for unconventional oil and gas extraction processes, characterized by the fact that it comprises the proppant from claim 1, and further comprises a polymeric viscosity modifier selected from guar gum, tara gum or polyacrylonitriles; it may also comprise other proppants, crosslinkers, friction reducers, antifoaming agents, emulsifiers, corrosion inhibitors, scale inhibitors, paraffin inhibitors, clay stabilizers, biocides and chain breakers.

8. Synthetic nanocomposites in microparticle form formulated from polybutadienes, and other polydienes, capable of withstanding great deformation before breaking, with applications in diverse fields of industry, especially in the preparation of low density synthetic proppants to be used in unconventional oil and gas extraction processes (fracking), in bearings for the slide of very heavy parts in the construction and mechanical industries, in torque reducers for the drilling of oil wells and other types of wells, characterized by the fact that said nanocomposites are obtained by means of suspension copolymerization in an aqueous medium of styrene drops containing crosslinking agents dissolved in said drops and having at least two bifunctional reactive sites, generating free radicals by means of peroxide thermal decomposition, with control of the stoichiometry of styrene and the crosslinking agent and of the progression of reaction temperatures, the stoichiometric ratios of styrene double bonds to crosslinking agent double bonds ranging from 3 to 60 styrene double bonds per each crosslinker double bond in the original reaction mixture, and the reaction temperatures being in ascending slopes between 65° C. and 250° C.
